(19) United States
(12) Patent Application Publication
(10) Pub. No.: US 2012/0030496 A1
(43) Pub. Date: Feb. 2, 2012

(54) Specification of Isochronous Data Transfer in a Graphical Programming Language

(76) Inventors: Sundeep Chandhoke, Austin, TX (US); Timothy J. Hayles, Austin, TX (US); Jeffrey L. Kodosky, Austin, TX (US)

(21) Appl. No.: 12/846,970

(22) Filed: Jul. 30, 2010

(51) Int. Cl. G06F 3/01; G06F 1/12

(52) U.S. Cl. 713/400; 715/748

(57) ABSTRACT

System and method for transferring data. A system diagram is displayed, where the system diagram includes multiple device icons corresponding to respective devices, each device icon having associated executable function nodes specified for deployment on the corresponding device. The function nodes are interconnected to form a distributed graphical program that is deployable and executable in a distributed manner on the devices. User input is received to the system diagram specifying isochronous data transfer among the function nodes. Invocation timing relationships among the function nodes are automatically determined based on the specified isochronous data transfer, including phase relationships between execution of the function nodes. The determined invocation timing relationships are displayed among the function nodes. The graphical program is deployable and executable in a distributed manner on the devices according to the determined invocation timing relationships, where during execution of the graphical program, data are transferred isochronously between the function nodes.

### FIELD OF THE INVENTION

The present invention relates to the field of programming, and more particularly to specification of isochronous data transfer in a graphical programming language.

### DESCRIPTION OF THE RELATED ART

Programmable controllers are well-known systems for operating industrial embedded equipment such as machines and assembly lines. In these controllers, a written program is executed to examine the condition of specific sensing devices on the controlled equipment and to turn actuators on and off based on the status of these inputs. Systems are becoming increasing complex and often include a number of sub-systems (e.g., modules) working together in a coordinated manner. In such cases, multiple programmable controllers are used to execute respective parts of the program. These different parts of the program control different parts of the system and need to exchange data deterministically amongst themselves in a time bounded fashion.

Specifying the system level program for such a distributed system has generally been very difficult because prior art programming languages do not include means to specify isochronous (time based) operation across subsystems. Note that the time basis for such isochronous operation in such systems is not absolute, but rather is a phase relationship execution semantic. In other words, the critical temporal behavior between the coordinating subsystems is relative, i.e., to each other, not with respect to some absolute clock.

### SUMMARY OF THE INVENTION

Various embodiments of a system and method for specifying isochronous data transfer in a graphical programming language are presented below.

First, a system diagram may be displayed on a display of the computer, where the system diagram includes a plurality of device icons corresponding to respective devices, and where each device icon has an associated respective one or more executable function nodes specified for deployment on the corresponding device. The function nodes may be interconnected to form a distributed graphical program that is deployable and executable in a distributed manner on the devices. Thus, the system diagram may represent or specify a distributed system in which a distributed graphical program is deployed and executed across multiple devices. Note that the distributed system may be or include any of a wide variety of applications. For example, in some embodiments, the system diagram may specify a distributed control system, a distributed timed data acquisition system, or a distributed audio and/or video system, among others. Additionally, in some embodiments, the graphical program may be or include a graphical data flow program.

User input may be received to the system diagram specifying isochronous data transfer among two or more of the function nodes. In some embodiments, receiving user input to the system diagram specifying isochronous data transfer among two or more of the function nodes may include receiving user input interconnecting the two or more function nodes, where each interconnection may include an isochronous data flow wire that a specifies isochronous data transfer between two function nodes, i.e., transfer of cyclic data with guaranteed bandwidth with bounded latency, e.g., data sent with statically defined time offsets (discussed in more detail below). In some embodiments, further user input may be received specifying additional aspects of the distributed system. For example, in one embodiment, the method may include receiving user input to the system diagram specifying execution rates for the two or more function nodes, where during execution of the graphical program, the two or more function nodes execute according to their respective specified execution rates. In other words, the user may provide input specifying how often each of the two or more function nodes executes. Note that the execution rates may be specified or represented in any of a variety of ways, e.g., by specifying a frequency, e.g., executions per unit time, and/or an execution period, e.g., time between executions (e.g., a period of 2 milliseconds means that the node executes every 2 milliseconds).

In some embodiments, each device may include a clock, which may be represented by a clock symbol displayed on or approximate to the corresponding device node, and the method may further include receiving user input specifying a clock hierarchy among the clocks of the devices, where the clock hierarchy includes a master clock and one or more slave clocks. The clock hierarchy may be specified by the user connecting a selected master clock symbol (e.g., the clock symbol on the controller A device node) to the clock symbols on the other controller device nodes. These connections or wires may be indicated or distinguished from the data wires graphically, e.g., using large dashed (directed) lines to indicate the clock hierarchy, i.e., to indicate “clock disciplining direction”, although any other distinguishing means may be used as desired. During execution of the graphical program, the specified clock hierarchy may be used to synchronize the clocks to achieve and maintain the determined phase relationships between executions of the two or more function nodes.

As indicated above, in some embodiments, the data production and consumption among nodes in the diagram are specified to be in phase. Thus, for example, every cycle, data that are produced by the path planner node (or actor) may be consumed by the motor control program nodes (or actors). Additionally, there may be some data that are not updated every cycle, e.g., configuration parameters, alarms, etc, which may be sent “asynchronously”, i.e., sporadically or on-demand only. Hence in some embodiments, the nodes may include multiple I/O ports corresponding to different types of data. Any other line types or graphical means may be used to distinguish wires for different types of data transfer as desired, e.g., line colors, line shapes, line size, labels, and so forth.

Isochronous connections between nodes (actors) on the same target (controller) may allow the compiler to generate an offset between the start of execution of one node with respect to the other, which may ensure that the most current data produced by the one node is being consumed by the other node. To achieve the desired or specified phase offset behavior across targets (controllers), clock synchronization across targets may be required. Thus, once an isochronous connection between nodes across targets is established, the clock connection between these targets may be pertinent. As noted above, the relationships among clocks in the system may be represented by showing the clock hierarchy across targets. In some embodiments, the user can modify the connection (e.g., choosing the best clock to be the master) but cannot delete this connection, because deleting it may make the isochronous connection invalid. These clock connections may indicate to the compiler the need for synthesis (automatic generation) of logic needed to synchronize clocks (PLLs, clock recovery, etc).

Invocation timing relationships among the two or more of the function nodes may be automatically determined based on the specified isochronous data transfer above, including phase relationships between executions of the two or more function nodes. In other words, the determined invocation relationships among the function nodes include the timing relationship between respective invocations/executions of the function nodes.

The determined invocation timing relationships among the two or more function nodes may be displayed. Note that in various embodiments, the display of the determined invocation timing relationships among the two or more function nodes may be implemented and performed in a variety of ways, as described below.

For example, in one embodiment, displaying the determined invocation timing relationships among the two or more function nodes may include displaying a timing generator in the system diagram, where the timing generator may be or include a control node that orchestrates invocation and execution of function nodes in and across devices, and also displaying timed invocation wires connecting the timing generator to each of the two or more function nodes in the system diagram, where each timing wire indicates an invocation period for the connected function node. In a further embodiment, at least one invocation timing wire may indicate or be configured with an execution offset for the connected function node, where the execution offset specifies a delay in execution of the connected function node with respect to execution of another function node that provides input data to the connected function node. During execution of the graphical program, the connected function node may execute at its specified execution rate but with the specified execution offset with respect to the other function node (providing its input). This offset may thus be used to specify and maintain a desired phase relationship between execution of the nodes that may, for example, take into account latencies between nodes caused by travel time over transmission media coupling the executing nodes. Note, for example, that if two nodes are deployed on respective devices, then if one of the nodes invokes the other, it may take some time for the invocation to be communicated over cables (or wireless transmission media) coupling the respective devices, and so an offset may be used to properly synchronize or maintain phase between the two nodes.

In some embodiments, the system diagram may be further modified by the user. For example, the user may edit the system diagram to modify any of the relations indicated in the diagram. These edits may include modifying the original relationships specified by the user and/or modifying the timing invocation relations that were automatically determined and displayed. In one embodiment, once these edits are performed, the method may include re-determining at least some of the timing invocation relationships per the new edits.

As mentioned above; the specification of isochronous wires across nodes allows the compiler to generate offsets for when a node executes (fires) within its cycle with respect to the node(s) it is connected to. In many cases it may be desirable for the users to view this offset and additionally to modify the offsets to account for execution and data transfer time over and above that assumed by the compiler. In order to do this, an option may be presented to the user to invoke display of a timing view for the application (system diagram). This timing view may include or represent a timing generator orchestrating the firing of the nodes connected isochronously to each other.

Thus, in some embodiments, displaying the determined invocation timing relationships among the two or more function nodes may include displaying a timing diagram indicating the determined invocation timing relationships among the two or more function nodes, where the timing diagram further indicates input/output data dependencies among the two or more function nodes. The timing diagram may be automatically generated based on the system diagram. In one embodiment, the timing generator may symbolically represent the timing diagram. Moreover, the user may invoke display of the timing diagram via input to the timing generator in the system diagram, e.g., by double clicking, right-clicking to invoke a menu, etc., as desired.

Said another way, in one embodiment, to invoke display of a graphical view of execution timelines associated with the system diagram, the user may open (or invoke display of) a view associated with the timing generator that shows the firing times of all the nodes or actors in the system diagram. In this view, the user may simply slide the invoke times along the time axis of the view to adjust the offset.

In some embodiments, the method may further include receiving user input to the timing diagram modifying the determined invocation timing relationships among the two or more function nodes. For example, the user may move, delete, etc., various of the elements in the timing diagram, as desired. Thus, for example, the user may modify the transfer and execution time period, e.g., possibly increasing, but not reducing it beyond a certain amount, since there may be platform dependent times or durations associated with data transfer and propagation delays. In this exemplary embodiment, shifting the arrows (left or right) changes the offset within the period. Also if a node or actor is shown executing multiple times; then moving one arrow moves the other ones automatically. Note that execution rates and offsets are clearly visible and modifiable on the timing diagram, and thus may be easier to quickly understand and manage using this timing diagram (view), as compared to the system diagram.

In some embodiments, in response to at least some of the changes made to the timing diagram, the method may include automatically updating the system diagram accordingly.

Once the timing for the system has been specified, the graphical program (portion of the system diagram) may be deployable and executable in a distributed manner on the devices according to the determined invocation timing relationships, where during execution of the graphical program, data are transferred isochronously between the two or more function nodes. Thus, in one embodiment, the method may include deploying the graphical program on the devices, including deploying each of the respective one or more function nodes to their associated devices, and executing the graphical program, including executing the respective one or more function nodes on their devices.

Thus, embodiments of the above method may operate to specify and implement isochronous data transfer among nodes of a graphical program distributed in and across multiple devices.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system configured to implement embodiments of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 illustrates an exemplary distributed control system, according to one embodiment;

FIG. 6 is a flowchart diagram illustrating one embodiment of a method for specifying isochronous data transfer in a graphical programming language;

FIG. 7 illustrates an exemplary system diagram with specified isochronous data transfer, according to one embodiment;

FIG. 8 illustrates the exemplary system diagram of FIG. 7, including automatically generated invocation timing relationships, according to one embodiment;

FIG. 9 illustrates an exemplary timing diagram corresponding to the system diagram of FIG. 8, according to one embodiment; and

FIG. 10 illustrates an edited version of the timing diagram of FIG. 9, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference

The following references are hereby incorporated by reference in their entirety as though fully and completely set forth herein:
U.S. Pat. No. 4,914,568 titled “Graphical System for Modeling a Process and Associated Method,” issued on Apr. 3, 1990.
U.S. Pat. No. 5,481,741 titled “Method and Apparatus for Providing Attribute Nodes in a Graphical Data Flow Environment”.
U.S. Pat. No. 6,173,438 titled “Embedded Graphical Programming System” filed Aug. 18, 1997.
U.S. Pat. No. 6,219,628 titled “System and Method for Configuring an Instrument to Perform Measurement Functions Utilizing Conversion of Graphical Programs into Hardware Implementations,” filed Aug. 18, 1997.
U.S. Pat. No. 7,210,117 titled “System and Method for Programmatically Generating a Graphical Program in Response to Program Information,” filed Dec. 20, 2000.
U.S. patent application Ser. No. 11/776,196, titled “Diagram That Visually Indicates Targeted Execution”, filed Jul. 11, 2007, which published as U.S. Patent Publication No. 2008/0034310 A1.
U.S. patent application Ser. No. 11/759,991, titled “Diagram with Configurable Wires”, filed Jun. 8, 2007, which published as U.S. Patent Publication No. 2008/0034079 A1.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Diagram—A graphical image displayed on a computer display which visually indicates relationships between graphical elements in the diagram. Diagrams may include configuration diagrams, system diagrams, physical diagrams, and/or graphical programs (among others). In some embodiments, diagrams may be executable to perform specified functionality, e.g., measurement or industrial operations, which is represented by the diagram. Executable diagrams may include graphical programs (described below) where icons connected by wires illustrate functionality of the graphical program. Alternatively, or additionally, the diagram may comprise a system diagram which may indicate functionality and/or connectivity implemented by one or more devices. Various graphical user interfaces (GUIs), e.g., front panels, may be associated with the diagram.

Graphical Program—A program comprising a plurality of interconnected nodes or icons, wherein the plurality of interconnected nodes or icons visually indicate functionality of the program. A graphical program is a type of diagram.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DiaDem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, VisSim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Data Flow Graphical Program (or Data Flow Diagram)—A graphical program or diagram comprising a plurality of interconnected nodes, wherein the connections between the nodes indicate that data produced by one node is used by another node.

Physical Diagram—A diagram which visually indicates physical connectivity between physical devices. For example, a physical diagram may visually indicate the connectivity of various physical components in a measurement system, e.g., a computer connected to a measurement device via an Ethernet network. Thus the wires in a physical diagram represent physical connectivity between devices. A physical diagram may show the corresponding “real world” physical system/devices.

Configuration Diagram—A diagram which indicates connectivity between real and/or virtual devices. A configuration diagram may visually indicate physical connectivity between physical devices as shown in a physical diagram. However, in some embodiments, one or more of the devices (or all of the devices) in the configuration diagram may be virtual or simulated devices. Thus, some or all of the devices in the configuration diagram may not be physically present in the system represented by the configuration diagram.

System Diagram—A diagram with one or more device icons and graphical program code, wherein the device icons are use to specify and/or visually indicate where different portions of graphical program code are deployed/executed. A system diagram may indicate where (i.e., on which system/device) programs or code may be executed. For example, the system diagram may include graphical indications showing where portions of the displayed graphical program code are executed. In some embodiments, various ones of the icons may represent processing elements which have associated programs for execution. At least one of the icons may represent logical elements (e.g., executable software functions or graphical program code). One or more of the device icons may represent configurable elements. Thus, the system diagram may provide a system view which allows a user to easily understand where graphical program code is deployed among the various devices in the system.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes (sub-Vis), terminal nodes, structure nodes, etc. Nodes may be connected together in a graphical program by connection icons or wires. The term “logical element” is used herein to refer to a “node”. For example, the term “logical element: may refer to a software program portion or code that is executable by (or implementable on) a processing element, and which is represented iconically on a display. Logical elements include virtual instruments (VIs), primitives, etc. Logical elements may be displayed in various ones of the diagrams described herein, e.g., in graphical programs, system diagrams, etc.

Wire—a graphical element displayed in a diagram on a display that connects icons or nodes in the diagram. The diagram may be a graphical program (where the icons correspond to software functions), a system diagram (where the icons may correspond to hardware devices or software functions), etc. The wire is generally used to indicate, specify, or implement communication between the icons, or that express or specify a connection or relationship between the icons (or entities represented by the icons). Wires may represent logical data transfer between icons, or may represent a physical communication medium, such as Ethernet, USB, etc. Wires may implement and operate under various protocols, including data flow semantics, non-data flow semantics, etc. Some wires, e.g., buffered data transfer wires, may be configurable to implement or follow specified protocols or semantics. Wires may indicate communication of data, timing information, status information, control information, and/or other information between icons. In some embodiments, wires may have different visual appearances which may indicate different characteristics of the wire (e.g., type of data exchange semantics, data transport protocols, data transport mediums, and/or type of information passed between the icons, among others).

Data Flow Wire—a graphical element displayed in a diagram on a display that connects icons or nodes in the diagram and denoting that data is exchanged between the two icons or nodes.

Isochronous Data Flow Wire—a graphical element displayed in a diagram on a display that connects icons or nodes in the diagram, which denotes that data is exchanged between the two entities and that further denotes and constrains the exchange of data to occur periodically, at a fixed rate that remains constant over time. The data exchange path or transmission media (e.g., PCI bus) may be managed such that it is available to exchange the data at the appointed time, thus guaranteeing bandwidth for the transfer, and providing an upper bound for the data's arrival time (transfer latency).

Clock Disciplining Wire—a graphical element displayed in a diagram on a display that connects two clocks in a clock hierarchy, and that establishes a master/slave relationship between the two clocks.

Timed Invocation Wire—a graphical element displayed in a diagram on a display that connects two nodes or icons, where a first node or icon invokes (causes execution of) a second node or icon connected by the timed invocation wire to the first node or icon. The first node or icon determines the execution rate of the second node or icon by communicating the execution rate to the second node or icon via the timed invocation wire, or, alternatively, by sending invocation commands (or events) to the second node or icon via the timed invocation wire or by some other mechanism.

Timing Wire—a graphical element displayed in a diagram on a display that connects two entities (e.g., nodes or icons), and that implies a timing relationship between them. The timing relationship may be any of a master/slave clock disciplining relationship or an invocation timing relationship.

Invocation Timing Relationship—a relationship in which a first node or icon is connected to a second node or icon by a timed invocation wire where the execution rate of the second node or icon is controlled by the first node or icon.

Execution Rate—the number of invocations per unit time of an entity.

Execution Offset—a delay in the execution of one node or icon with respect to execution of another node or icon, where, e.g., a first node or icon is connected to a second node or icon by a timed invocation wire where the execution rate of the second node or icon is controlled by the first node or icon. The moment of execution of the second node or icon may be configured to be delayed (or offset) from the time strictly determined by the first node or icon.

Timing Generator—a node on a graphical diagram that is the source of timed invocation wires.

Timing Diagram—a graphical diagram depicting the master/slave relationships and invocation timing relationships of all the entities (e.g., nodes or icons) in a system.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a diagram, e.g., a graphical program. In this instance, various mechanisms may be used to connect GUI Elements in the GUI with nodes or icons in the diagram/graphical program. For example, when Input Controls and Output Indicators are created in the GUI, corresponding nodes (e.g., terminals) may be automatically created in the diagram or graphical program. Alternatively, the user can place terminal nodes in the diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program or diagram, and view output of the program or diagram, during execution.

A front panel is a type of GUI. A front panel may be associated with a diagram or graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators

Input Control—a graphical user interface element for providing user input to a program. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Processing Element—A hardware component or device which is operable to execute software, implement code (e.g., program code), be configured according to a hardware description, etc. Processing elements include various processors and/or programmable hardware elements (e.g., field programmable gate arrays (FPGAs)), or systems that contain processors or programmable hardware elements, among others. For example, a processing element may refer to an individual processor in a computer system or the computer system itself.

Configurable Elements—Systems or devices that provide configurable functionality but do not themselves includes processors that process data. Configurable elements may produce and/or consume data that may be provided to or received from various processing elements. A configurable element may have or receive configuration data that specifies functionality of the configurable element. Configurable elements comprise data acquisition (DAQ) devices and/or other sensors/devices.

Clock—a periodic signal, e.g., as in a two valued (binary) electrical signal; an entity that can be queried for a timestamp.

Timestamp—a data representation of time; an indication of when a record was generated or acquired, e.g., in terms of a tick count of a clock, a single unit of time, e.g., seconds, a multi-unit instant in time, e.g., year:month:day:hours:minutes:seconds:sub-seconds.

Clock Hierarchy—a collection of two or more clocks that share in a synchronization scheme such that all the clocks in the hierarchy agree on the time, where one clock operates as master clock and the others operate as slaves. The synchronization scheme may insure that all the periodic binary electrical signals in the hierarchy have a fixed phase relationship, and that all clocks return equal valued timestamps when queried at the same instant.

Phase Relationship—the relative time between like changes in value of two or more binary electrical signals. The phase relationship is ‘fixed’ when the relative time of these like value changes between the signals is constant over the life of the signals.

Clock Symbol—a node on a graphical diagram that represents a clock.

Master Clock—a first clock in a clock hierarchy with which the remaining clocks in the hierarchy must agree.

Slave Clock—a second clock in a clock hierarchy whose timing is forced to agree with a first clock in the clock hierarchy where the first clock is called the master clock.

Master/Slave Relationship—a first clock in a clock hierarchy forces a second clock in the clock hierarchy to agree with the first clock, including maintaining a fixed phase relationship between first and second binary valued electrical signals, and timestamp equivalency for simultaneous first and second clock timestamp queries. The first clock is the master in this relationship between the two clocks, and the second clock is the slave in this relationship.

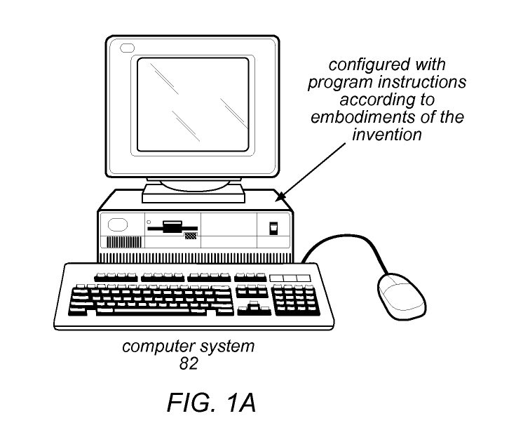

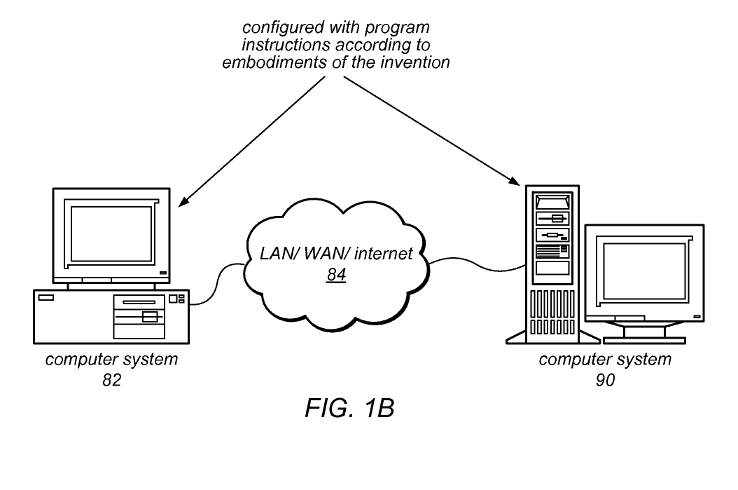

### FIG. 1A—Computer System

FIG. 1A illustrates a computer system 82 configured to implement embodiments of the present invention. One embodiment of a method for specifying isochronous data transfer in a programming language is described below.

As shown in FIG. 1A, the computer system 82 may include a display device configured to display a graphical program as the program is created and/or executed. The display device may also be configured to display a graphical user interface or front panel of the graphical program during execution of the program. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more programs which are executable to perform the methods described herein. Additionally, the memory medium may store a programming development environment application used to create and/or execute such programs. For example, the programming development environment application may include program elements for specifying isochronous data transfer between portions of a distributed application program executing on respective controllers. The memory medium may also store operating system software, as well as other software for operation of the computer system. In some embodiments, the program(s) may be or include graphical programs, and the programming development environment application may be or include a graphical programming development environment, such as the LabVIEW™ graphical programming system provided by National Instruments Corporation. In some embodiments, the graphical programs may be or include system diagrams whose nodes include function nodes and device nodes that represent hardware devices. For more detailed information regarding such system diagrams, please see U.S. patent application Ser. No. 11/776,196, titled “Diagram That Visually Indicates Targeted Execution”, and U.S. patent application Ser. No. 11/759,991, titled “Diagram with Configurable Wires”, both of which were incorporated by reference above.

Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a program, e.g., a graphical program, in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system.

In some embodiments, once the program (which may include multiple programs) is developed, it may be deployed to one or more industrial controllers. As used herein, the term “controller” refers to a computing device that couples to one or more other devices, e.g., peripheral devices, motion drives, actuators, etc., and which may be configured to communicate with, e.g., to control, such devices.

For example, in one embodiment the controllers may be embedded devices, e.g., in a distributed control system, e.g., a distributed motion control system. As used herein, the term “embedded device” refers to a small platform which includes dedicated hardware, and which includes a processor and memory (or FPGA) on which may be installed dedicated programs or software. An embedded device is typically designed to perform a defined task very well. In particular, an embedded device is typically not a device with general capabilities, such as a PC or PXI controller, for example, loaded with one or several plug-in boards, running a Microsoft OS with generous amounts of memory, system files, utilities, etc, that can be used as a measurement system, or as an office computer, or as a Web browser, etc. Thus, for example, an embedded controller may not include display capabilities typical of home computers or workstations. In some embodiments, the embedded controllers may be accessible, e.g., for monitoring or configuring, via a temporary interface, e.g., via connecting the controllers to a host computer, e.g., computer 82 or 90, which provides GUI functionality. Alternatively, in some embodiments, the controllers may be accessed via a web interface utilizing a web browser. Of course, any other means for interfacing with the controllers may be used as desired.

In other embodiments, the industrial controllers may be or include personal computers or workstations, as illustrated in FIGS. 1A and 1B.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

Additionally, the techniques disclosed herein may be further applicable in other domains, such as, for example, audio/video applications, timed data acquisition, radio frequency applications, etc., among others.

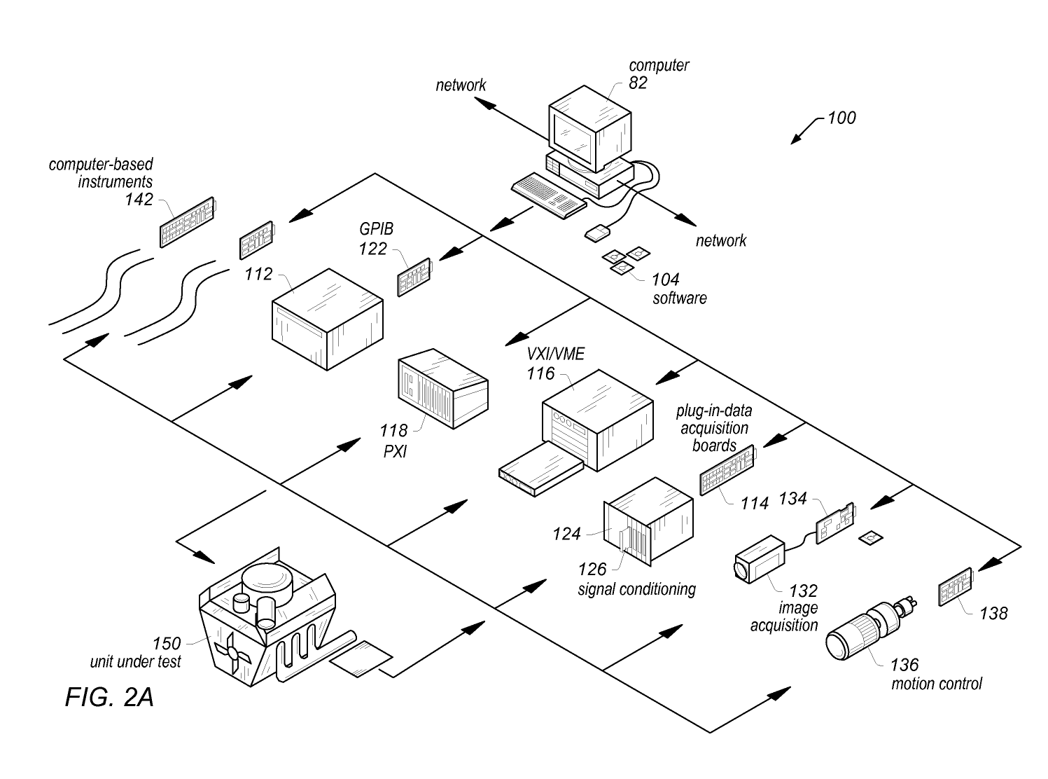

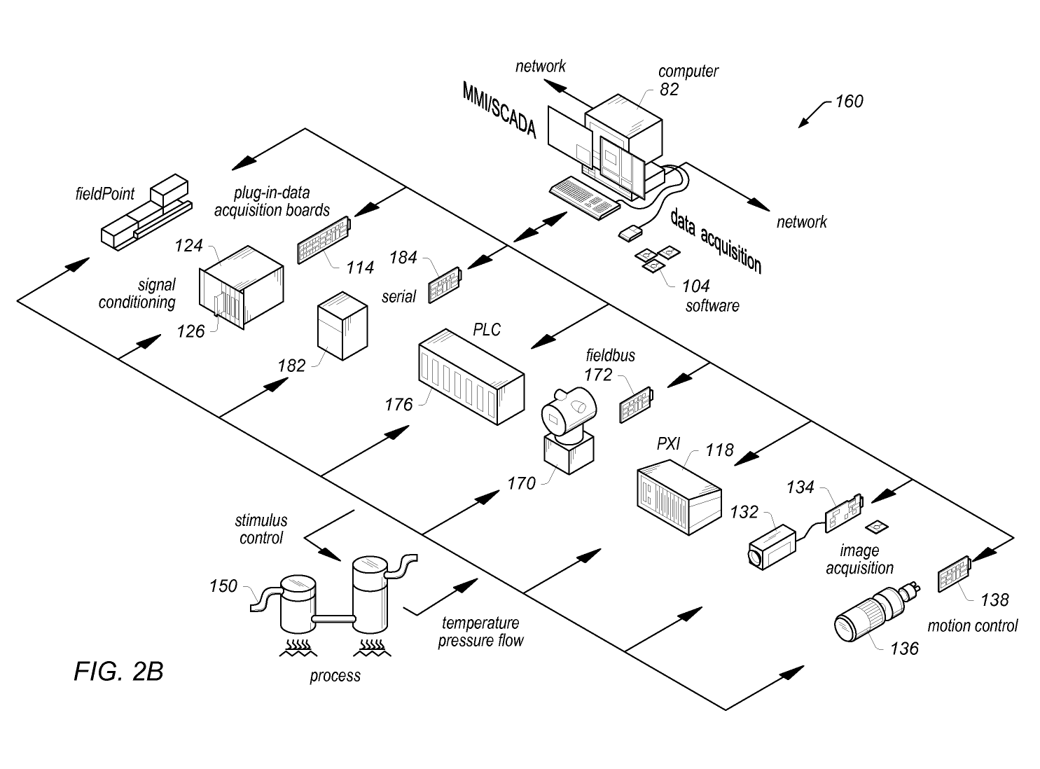

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to perform an automation function with respect to a process or device 150, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

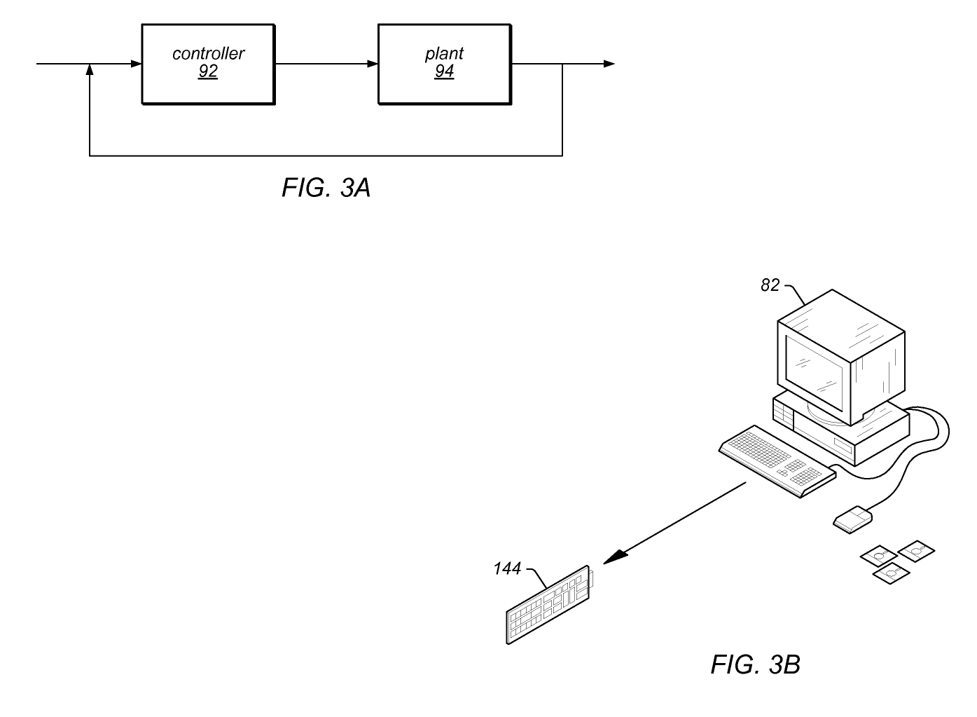

FIG. 3A is a high level block diagram of an exemplary system which may execute or utilize programs according to some embodiments. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a program, e.g., a graphical program, that specifies or implements the functionality of one or both of the controller 92 and the plant 94. For example, a control engineer may use a modeling and simulation tool to create a model (e.g., program) of the plant 94 and/or to create the algorithm (program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a program. In a similar manner, the plant 94 may be implemented by a computer system or other device 144 (e.g., including a processor and memory medium and/or including a programmable hardware element) that executes or implements a program, or may be implemented in or as a real physical system, e.g., a car engine.

In one embodiment of the invention, one or more programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a program, e.g., a graphical program, and the program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a program. Thus the user may create a program on a computer and use (execute) the program on that computer or deploy the program to a target device (for remote execution on the target device) that is remotely located from the computer and coupled to the computer through a network. As noted above, in some embodiments, the program or programs implementing or implemented by the present invention may be graphical programs.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

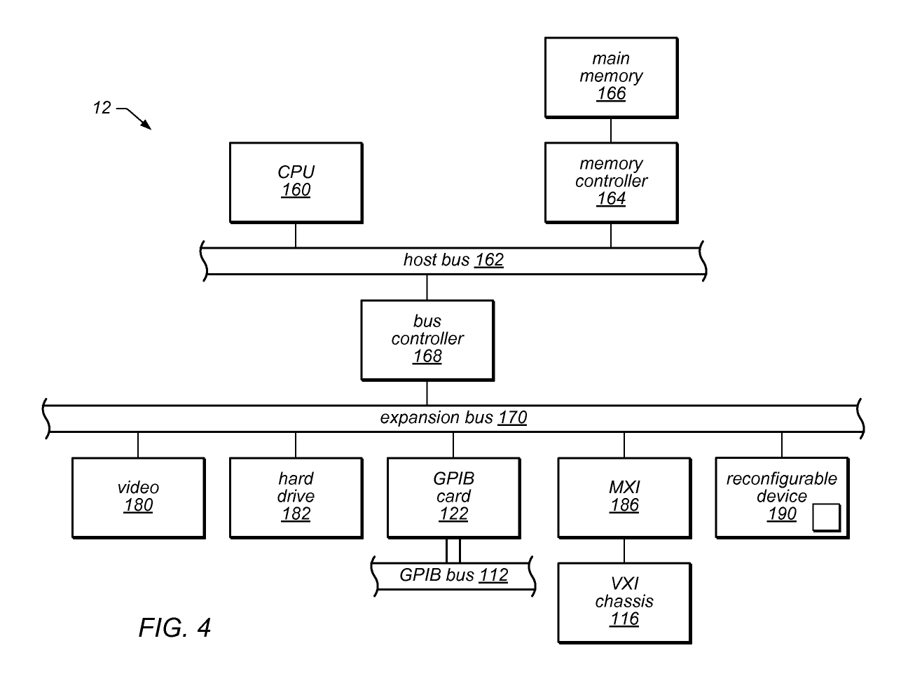

### FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, a controller, e.g., an embedded controller, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the program(s) configured to implement embodiments of the invention. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170. The computer 82 may also comprise a GPIB card 122 coupled to a GPIB bus 112, and/or an MXI device 186 coupled to a VXI chassis 116.

As shown, a device (or multiple devices, e.g., controllers) 190 may also be connected to the computer. The device 190 may include a processor and memory which may execute a real time operating system. The device 190 may also or instead comprise a programmable hardware element. The computer system may be configured to deploy a program to the device 190 for execution. The deployed program may take the form of graphical program instructions or data structures that directly represents the graphical program. Alternatively, the deployed program may take the form of text code (e.g., C code), which may be written, or generated from a graphical program. As another example, the deployed program may take the form of compiled code generated from either the graphical program or from text code, which may itself have been generated from the graphical program.

In some embodiments, the synchronization problem mentioned above may be addressed by specifying in a programming language an isochronous connection between independently executing software/hardware actors (i.e., programs, subprograms, etc., executing on hardware devices) in a distributed control system in order to “phase adjust” their firing instances (program execution) taking into account data transfer time. In other words, the programming language in which the distributed control application programs are developed may provide for the specification of isochronous data transfer among portions of the application so that the overall functionality of the application is coherent, i.e., is synchronized, for proper operation and performance of the control system. Thus, in one embodiment, a set of timing semantics may be provided in or by a programming language which allows specification of isochronous data transfer between actors, e.g., programs or program portions.

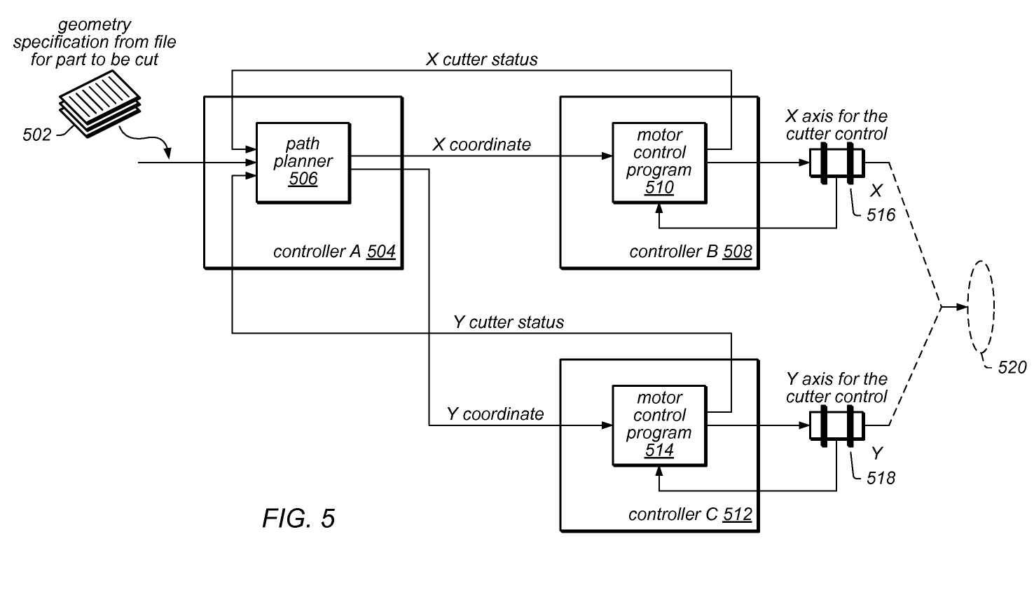

To illustrate these ideas, consider an example system that uses multiple programmable controllers and where parts of the application program need to exchange data in a time bounded fashion and synchronize updates to physical outputs, as shown in FIG. 5.

### FIG. 5—Exemplary Control System

FIG. 5 is a simplified illustration of an exemplary distributed control system, according to one embodiment. Note that the exemplary system of FIG. 5 may be used to perform any of a variety of control tasks. For example, in one exemplary application, the system may implement a leather cutting machine, although this is but one exemplary application among many others.

As may be seen, in this embodiment, the system includes three controllers: controller A 504, which includes a path planner program 506, and controllers B 508 and C 512, each comprising a respective motor control program (motor control program 510 and motor control program 514) for controlling corresponding motors X 516 and Y 518, where each motor actuates some element 520, e.g., a cutter, camera, sensor, pen, etc., along a respective axis. The path planner and motor control programs (510 and 514) may be considered to be portions of a distributed motion controller, e.g., of a distributed motion controller program. Note that the particular names used for these elements are exemplary only, and that any other names are terms may be used as desired.

As indicated, the path planner 506 may be configured to receive a specification for a part to be cut, e.g., a geometry specification 502 for the part, and may generate and output successive x and y coordinates for the two motor control programs, which themselves may be configured to generate commands for their respective motors in accordance with the coordinates, and to receive and report the status of the actuator element 520, e.g., cutter, to the path planner. In other words, the path planner portion of the distributed motion controller analyzes the specification for the part (or pattern) to be cut (or otherwise implemented), and based on this and status feedback (e.g., position information) from the actuator element(s) (e.g., cutter), determines the next coordinate (which could be in absolute or relative terms) for each motion axis.

Considering the exemplary system of FIG. 5 as implementing a leather cutting machine that consists of the three controllers A 504, B 508, and C 512, a cutting tool (cutter, or, more generally, an actuator element) is physically connected to motors X 516 and Y 518, where the motion of motors X and Y move the cutter along a 2 dimensional plane. The interconnecting medium between controller A and controller B, and that between controller A and controller C, may be assumed to be a deterministic bus (i.e. the bus can guarantee transfer of data in both directions with bounded latency).

As shown, and as described briefly above, in this exemplary embodiment, the system program (the distributed control application) is split into three active execution elements or actors (although it should be noted that other application distribution or partitioning schemes may be used as desired):
1. The path planner program 506 (or functional equivalent) may execute on controller A 504. For example, the path planner may read a geometry specification 502 for a part, e.g., a computer aided design (CAD) input file, and may calculate the two dimensional geometry that needs to be followed to cut the leather every cycle. In one embodiment, a cycle correlates with one set of (x, y) points produced by the path planner, and so multiple cycles are required to cut one part. The cutter may move along the profile created by the path planner. Each cycle, the velocity on both motor control programs (510 and 514) may be updated to maintain the desired profile. To create the appropriate velocity set points every cycle, the calculated (x, y) positions may be fed to a position control loop along with current positions read every cycle from position sensors connected to the motors.
2. Motor control program 510 may execute on controller B 508, and may “consume” (accept as input and utilize) the velocity output produced by the path planner 506 for motor X 516 and use it as an input to a velocity control loop that maintains the specified velocity by controlling the torque of the motor X 516. Motor control program 510 may guarantee that its respective motor (motor X 516) will follow the velocity profile updated by the path planner every cycle, by deriving the current velocity (in the X direction) from the position read from the position sensor connected to the motor 516 and writing the torque output to the motor multiple times each cycle (i.e., multiple times per update from the path planner).
3. Analogously, motor control program 514 may execute on controller C 512, and may consume the velocity output produced by the path planner for motor Y 518, and use it as an input to another velocity control loop that maintains the specified velocity by controlling the torque of the motor Y 518. As with motor control program 510, motor control program 514 may guarantee that the motor connected to it (motor Y 518) will follow the velocity profile updated by the path planner 506 every cycle, by deriving the current velocity (in the Y direction) from the position read from the position sensor connected to the motor 518 and writing the torque output to the motor multiple times per cycle.

Note that both controller B and controller C may be required to write the torque outputs to their respective motors simultaneously every update (which occurs multiple times every cycle). This synchrony may be necessary because the cutting tool is connected to both motors, and so non-time aligned outputs may result in undesirable geometry which is not compliant with the geometry (e.g., CAD) specification.

Embodiments of the present invention may allow the user to implement such distributed control applications in a programming language explicitly using constructs that define the timing behavior, as described in detail below.

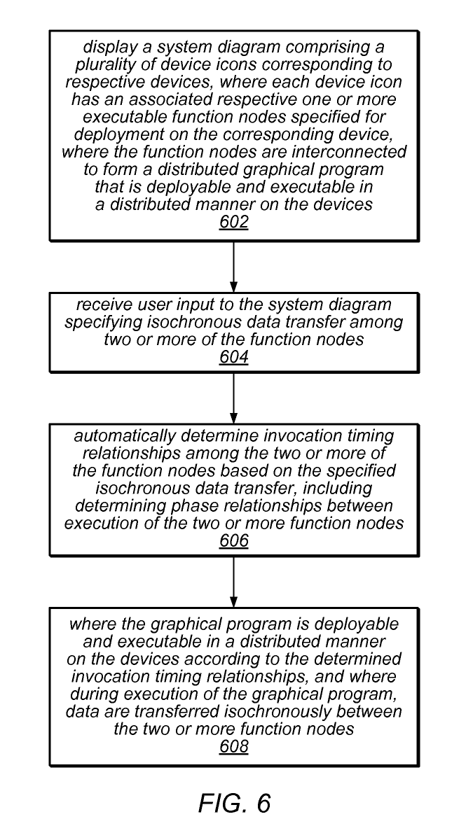

### FIG. 6—Flowchart of a Method for Specifying Isochronous Data Transfer in a Graphical Programming Language

FIG. 6 illustrates a method for specifying isochronous data transfer in a graphical programming language. The method shown in FIG. 6 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 602, a system diagram may be displayed on a display of the computer, where the system diagram includes a plurality of device icons corresponding to respective devices, and where each device icon has an associated respective one or more executable function nodes specified for deployment on the corresponding device. The function nodes may be interconnected to form a distributed graphical program that is deployable and executable in a distributed manner on the devices. Thus, the system diagram may represent or specify a distributed system in which a distributed graphical program is deployed and executed across multiple devices. Note that the distributed system may be or include any of a wide variety of applications. For example, in some embodiments, the system diagram may specify a distributed control system, a distributed timed data acquisition system, or a distributed audio and/or video system, among others. Additionally, in some embodiments, the graphical program may be or include a graphical data flow program. The system diagram may be created in any of a variety of ways, e.g., by a user dragging and dropping nodes or icons onto the diagram and interconnecting them. Exemplary approaches are described below.

In 604, user input may be received to the system diagram specifying isochronous data transfer among two or more of the function nodes. In some embodiments, receiving user input to the system diagram specifying isochronous data transfer among two or more of the function nodes may include receiving user input interconnecting the two or more function nodes, where each interconnection may include an isochronous data flow wire that specifies isochronous data transfer between two function nodes, i.e., transfer of cyclic data with guaranteed bandwidth with bounded latency, e.g., data sent with statically defined time offsets (discussed in more detail below). In some embodiments, further user input may be received specifying additional aspects of the distributed system. For example, in one embodiment, the method may include receiving user input to the system diagram specifying execution rates for the two or more function nodes, where during execution of the graphical program, the two or more function nodes execute according to their respective specified execution rates. In other words, the user may provide input specifying how often each of the two or more function nodes executes. Note that the execute rates may be specified or represented in any of a variety of ways, e.g., by specifying a frequency, e.g., executions per unit time, and/or an execution period, e.g., time between executions (e.g., a period of 2 milliseconds means that the node executes every 2 milliseconds).

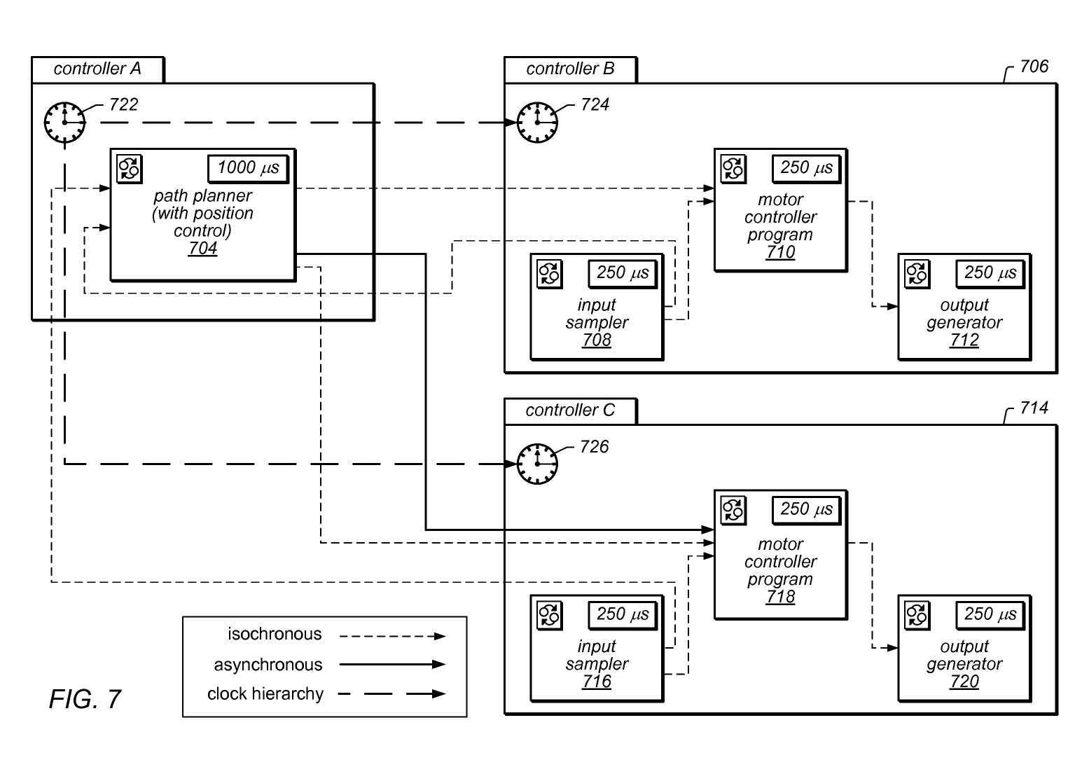

FIG. 7 is a simplified illustration of an exemplary system diagram according to one embodiment. More specifically, the system diagram of FIG. 7 implements or specifies one embodiment of a distributed control application as specified or implemented by a graphical program. In some embodiments, the exemplary system diagram (or distributed control application) of FIG. 7 may be implemented in a graphical programming language, such as the G programming language provided in the LabVIEW™ development environment provided by National Instruments Corporation. In this exemplary embodiment, software blocks implementing the leather cutting application are configured as periodically running actors (function nodes executing on hardware devices) with execution rates explicitly specified, as indicated by specified period values in the upper right corner of each block. The data exchange between the actors may be implemented via wires connecting communication ports on the actors or nodes to each other. In FIG. 7, the periodicity of the node executions is indicated by the “cycling” symbol in the top left of each function node.

Note that while the exemplary system diagram (including the graphical program) of FIG. 7 follows the example of FIG. 5, specifying and implementing control of a leather cutting machine, this is but one exemplary application among many others. In other embodiments, the system diagram may specify and/or implement applications for any of a variety of control tasks. Because the system diagram of FIG. 7 may be used to specify timing for the system via received user input to the diagram, FIG. 7 may be considered to illustrate an editor view of the system diagram/graphical program.

As FIG. 7 shows, in this embodiment, the system diagram includes device nodes that represent controllers A, B, and C (of FIG. 5), where each device node includes one or more respective function nodes representing programs deployed or slated for deployment on the devices. More specifically, the system diagram of FIG. 7 includes device node 702 representing controller A, device node 706 representing controller B, and device node 714 representing controller C. As may be seen, device node 702 (for controller A) includes a path planner node 704, which has been configured with an execution period of 1000 μs (microseconds), shown in the top right of the node, which specifies or corresponds to an execution rate of 1/1000 μs, i.e., the node is configured to execute once every 1000 μs.

As also shown, device nodes 706 (for controller B) and 714 (for controller C) each includes a respective motor controller program function node (710 and 718, respectively) configured with an execution period of 250 μs, which specifies or corresponds to an execution rate of 1/250 μs i.e., the nodes are configured to execute once every 250 μs. Note that each of these nodes (710 and 718) is coupled (via directed dashed connecting wires—see legend at bottom left of the figure) to I/O function nodes or modules whereby (during execution) input may be received to the node and output provided from the node; specifically, motor controller program node 710 is wired to input sampler 708 and output generator 712 (both with execution period 250 μs), and motor controller program node 718 is wired to input sampler 716 and output generator 720 (both also with execution period 250 μs), where the wires or connections are dashed lines in the diagram. Note further that the input sampler nodes (708 and 716) are further wired to provide output to the path planner node 704. Additionally, each of the motor controller program nodes 710 and 718 is also configured to receive input from the path planner node 704, as indicated by the dashed wires connecting them.

Additionally, regarding the system of FIG. 7, in some embodiments the geometry specification (element 502 of FIG. 5) may be pre-loaded on to controller A, and thus may not need to be explicitly received as input. The input sampler nodes 708 and 716 and output generator nodes 712 and 720 on controller B and controller C, respectively, may be endpoints which represent IO connections to the motors (516 and 518 of FIG. 5). Note that in an implementation language it may be important to specify the rate at which the IO data are sampled from or updated to the outside, i.e., physical, world (where discrete data in the system maps to continuous phenomena in the world). In the example system diagram of FIG. 7, the I/O nodes 708, 716, 712, and 720, are configured to execute at the rate of the fastest node (250 μs).

In some embodiments, each device may include a clock, which may be represented by a clock symbol displayed on or approximate to the corresponding device node, and the method may further include receiving user input specifying a clock hierarchy among the clocks of the devices, where the clock hierarchy includes a master clock and one or more slave clocks. The clock hierarchy may be specified by the user connecting a selected master clock symbol (e.g., the clock symbol on the controller A device node) to the clock symbols on the other controller device nodes. As the legend of FIG. 7 indicates, these connections or wires may be indicated or distinguished from the data wires graphically, e.g., using large dashed (directed) lines to indicate the clock hierarchy, i.e., to indicate “clock disciplining direction”, although any other distinguishing means may be used as desired. During execution of the graphical program, the specified clock hierarchy may be used to synchronize the clocks to achieve and maintain the determined phase relationships between executions of the two or more function nodes.

A subtle, but important point to note is that in some embodiments, the execution semantic of the actor (node) may be independent of the data arriving on the wire, which is different from traditional data flow programs in which an actor executes only when data are available on the input port of the actor. In contrast, with the system diagram of FIG. 7, if data are not available on a node's input port; the node may still execute when its period triggers. For example, in one embodiment, if data on the port are not updated the node may use old data (updated and saved from a previous cycle) for computation of new outputs. Thus, in some embodiments, during execution of the graphical program, if input data are not available to a function node, the function node may continue to execute in accordance with the function node's specified execution rate (or period) using previously received input data. In another embodiment, it may shut down (terminate execution) and produce an error.

As indicated above, in some embodiments, the data production and consumption among nodes in the diagram are specified to be in phase. Thus, for example, every cycle, data that are produced by the path planner node (or actor) may be consumed by the motor control program nodes (or actors). Additionally, there may be some data that are not updated every cycle, e.g., configuration parameters, alarms, etc, which may be sent “asynchronously”, i.e., sporadically or on-demand only. Hence in some embodiments, the nodes may include multiple I/O ports corresponding to different types of data. For example, referring again to FIG. 7, different types of wires may be used to distinguish between isochronous data transfer (wires) and asynchronous data transfer (wires), where in this example, asynchronous data (data exchanged on demand or sporadically) may be represented by solid lines, and “time bounded data”, i.e., data that are exchanged periodically (isochronously), may be represented by (small) dashed lines. Of course, any other line types or graphical means may be used to distinguish wires for different types of data transfer as desired, e.g., line colors, line shapes, line size, labels, and so forth.

In some embodiments, the rate of exchange of isochronous data between two nodes may be the Least Common Multiple (LCM) of the execution periods of the two nodes. Hence, referring to FIG. 7, the rate at which data are exchanged between the input sampler node 716 on controller C 714 and the path planner node 704 on controller A 702 may be 1000 μs (LCM[1000, 250]=1000). This implies that every 1000 μs, data from the input sampler node 716 on controller C 714 may be transferred to the path planner node 704 on controller A 702. In some embodiments, the isochronous wire semantic may also guarantee that the data are available on a port of the node before the node that consumes the data starts its execution in the cycle. Hence, an isochronous connection between nodes that are not configured for periodic execution may not make sense and thus may not be allowed. Additionally, in some cases, it may not make sense to fork (branch) an isochronous wire. The data can be sent only from the output port of one node to the input port of another.

Isochronous connections between nodes (actors) on the same target (controller) may allow the compiler to generate an offset between the start of execution of one node with respect to the other, which may ensure that the most current data produced by the one node is being consumed by the other node. To achieve the desired or specified phase offset behavior across targets (controllers), clock synchronization across targets may be required. Thus, once an isochronous connection between nodes across targets is established, the clock connection between these targets may be pertinent. As noted above, the relationships among clocks in the system may be represented by showing the clock hierarchy (see the long dashed wires connecting domain clocks in FIG. 7) across targets. In some embodiments, the user can modify the connection (e.g., choosing the best clock to be the master) but cannot delete this connection, because deleting it may make the isochronous connection invalid. These clock connections may indicate to the compiler the need for synthesis (automatic generation) of logic needed to synchronize clocks (PLLs, clock recovery, etc).

Thus, in one embodiment, the system diagram of FIG. 7 may be used to specify, edit, and graphical represent the distributed control system of FIG. 5.

In 606, invocation timing relationships among the two or more of the function nodes may be automatically determined based on the specified isochronous data transfer of 604 above, including phase relationships between executions of the two or more function nodes. In other words, the determined invocation relationships among the function nodes include the timing relationship between respective invocations/executions of the function nodes. For example, if some function node A executes at t1, and invokes execution of another function node B at t2, function node B may execute at t2, or, in other embodiments, may execute at t2+Δt, where Δt is an offset or delay applied to node B's execution with respect to the execution of node A and/or node A's invocation of node B, to maintain the specified phase relation against latencies between the nodes.

In 608, the determined invocation timing relationships among the two or more function nodes may be displayed. Note that in various embodiments, the display of the determined invocation timing relationships among the two or more function nodes may be implemented and performed in a variety of ways, as described below.

For example, in one embodiment, displaying the determined invocation timing relationships among the two or more function nodes may include displaying a timing generator in the system diagram, where the timing generator may be or include a control node that orchestrates invocation and execution of function nodes in and across devices, and also displaying timed invocation wires connecting the timing generator to each of the two or more function nodes in the system diagram, where each timing wire indicates an invocation period for the connected function node.

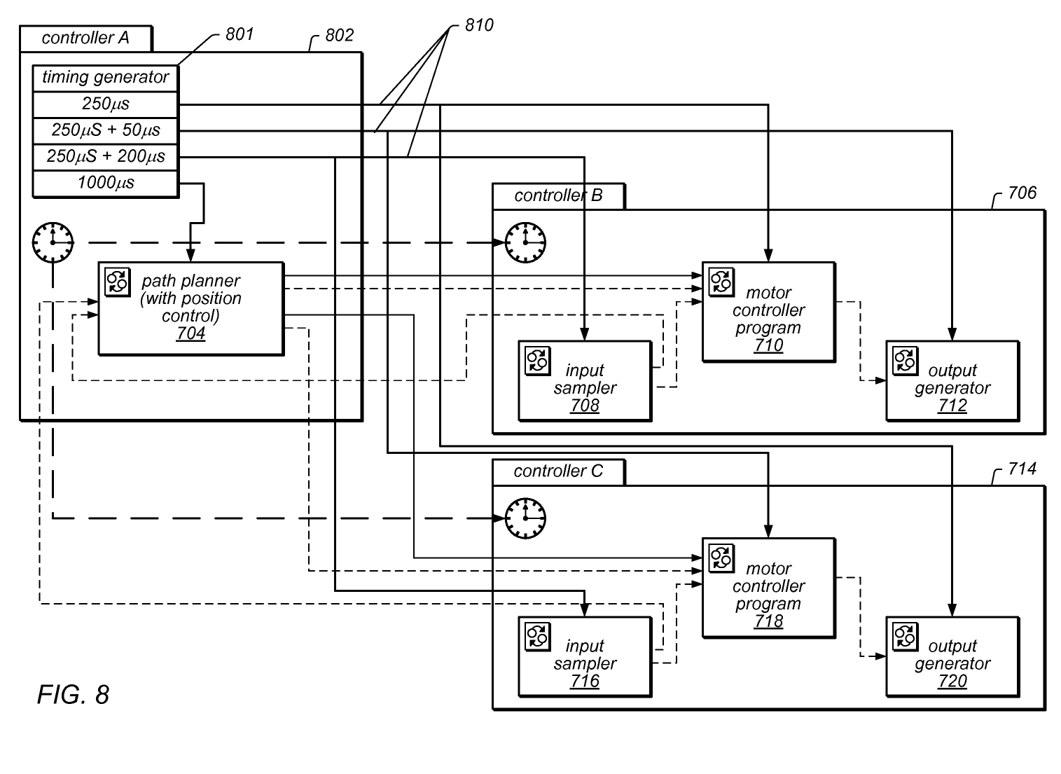

FIG. 8 illustrates an exemplary system diagram in which the determined invocation timing relations of 608 are displayed, e.g., in the context of a modified version of the system diagram of FIG. 7. As may be seen, in this exemplary embodiment, bold solid arrows 810 are displayed in the system diagram connecting a timing generator node 801 in device icon 802 (representing controller A), each representing a determined invocation timing relationship between the timing generator/control node 801 and the function nodes in the diagram.

In a further embodiment, at least one invocation timing wire may indicate or be configured with an execution offset for the connected function node, where the execution offset specifies a delay in execution of the connected function node with respect to execution of another function node that provides input data to the connected function node. For example, as FIG. 8 shows, various timing offsets corresponding to the timing invocation wires are listed in the timing generator.

During execution of the graphical program, the connected function node may execute at its specified execution rate but with the specified execution offset with respect to the other function node (providing its input). This offset may thus be used to specify and maintain a desired phase relationship between execution of the nodes that may, for example, take into account latencies between nodes caused by travel time over transmission media coupling the executing nodes. Note, for example, that if two nodes are deployed on respective devices, then if one of the nodes invokes the other, it may take some time for the invocation to be communicated over cables (or wireless transmission media) coupling the respective devices, and so an offset may be used to properly synchronize or maintain phase between the two nodes.

Note that in FIG. 8, the timing generator 801 has been placed on the node for controller A (802) primarily because it is the source for the “clock master” (per user specification in 604). Note, however, that there is no specific reason that it must be located on the controller A. In fact, in some embodiments, each controller may have its own timing generator which uses local disciplined clocks. Thus, in some embodiments, a hierarchy of timing generators may be presented which follows the specified clock hierarchy; however there may or may not be any significant benefit in this approach over showing a single central timing generator, per FIG. 8.

In some embodiments, the system diagram (e.g., of FIG. 8) may be further modified by the user. For example, similar to method element 604, the user may edit the system diagram to modify any of the relations indicated in the diagram. These edits may include modifying the original relationships specified by the user in 604, and/or modifying the timing invocation relations determined in 606, and displayed in 608. In one embodiment, once these edits are performed, the method may include re-determining at least some of the timing invocation relationships per the new edits.

As mentioned above; the specification of isochronous wires across nodes allows the compiler to generate offsets for when a node executes (fires) within its cycle with respect to the node(s) it is connected to. In many cases it may be desirable for the users to view this offset and additionally to modify the offsets to account for execution and data transfer time over and above that assumed by the compiler. In order to do this, an option may be presented to the user to invoke display of a timing view for the application (system diagram). This timing view may include or represent a timing generator orchestrating the firing of the nodes connected isochronously to each other.

Thus, in some embodiments, displaying the determined invocation timing relationships among the two or more function nodes may include displaying a timing diagram indicating the determined invocation timing relationships among the two or more function nodes, where the timing diagram further indicates input/output data dependencies among the two or more function nodes. The timing diagram may be automatically generated based on the system diagram. In one embodiment, the timing generator represented in FIG. 8 may symbolically represent the timing diagram. Moreover, the user may invoke display of the timing diagram via input to the timing generator 801 in the system diagram, e.g., by double clicking, right-clicking to invoke a menu, etc., as desired.

Said another way, in one embodiment, to invoke display of a graphical view of execution timelines associated with FIG. 8, described above, the user may open (or invoke display of) a view associated with the timing generator that shows the firing times of all the nodes or actors in the system diagram. In this view, the user may simply slide the invoke times along the time axis to adjust the offset.

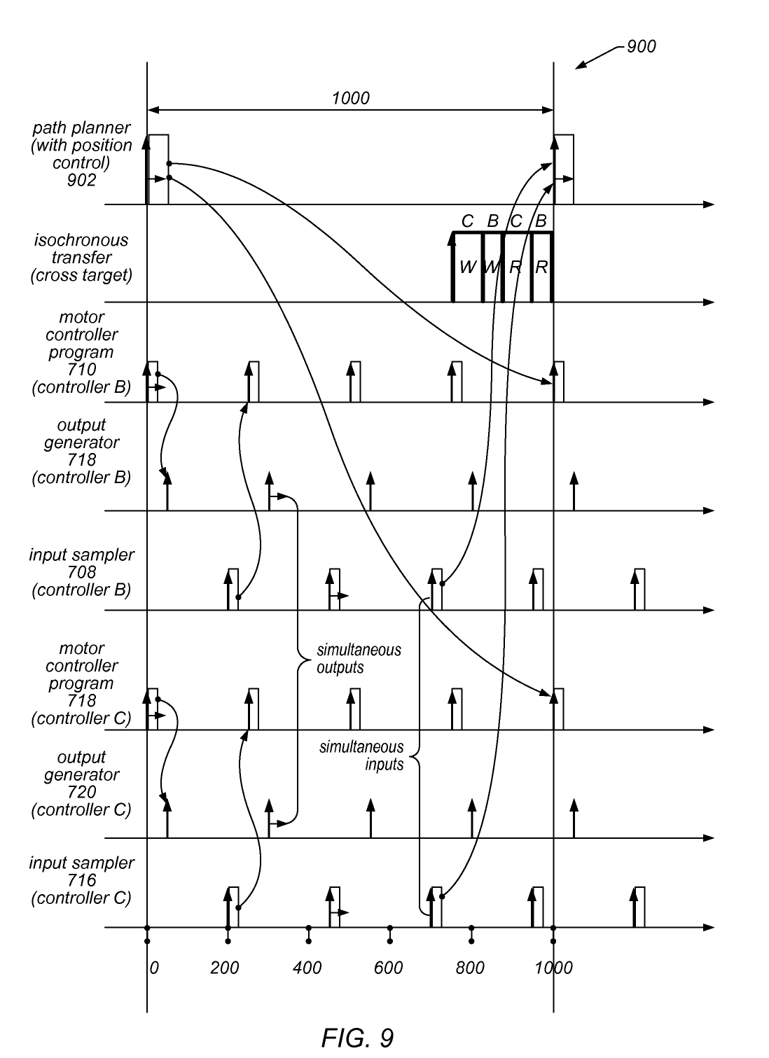

FIG. 9 illustrates an exemplary timing diagram 900 automatically generated based on the system diagram of FIG. 8, where the timing diagram displays execution timing relations over 1000 μs, which is the execution rate of the path planner. As may be seen, a timing row is displayed for each node or actor in the system diagram of FIG. 8, with executions indicated by upward pointing (execution timing) arrows, and data outputs, i.e., isochronous transfers, are indicated by right pointing arrows protruding from the upward pointing arrows, and connected to other execution indicators for recipient nodes with smooth curved solid arrows. Additionally, in this exemplary embodiment, the timing diagram also displays a row (second row from top) indicating isochronous transfer of data between the controllers A, B, and C, i.e., “cross target”, where isochronous reads and writes are indicated by “W” and “R”, respectively.

As indicated in FIG. 9, in some embodiments, some of the invoke times may be accompanied by transfer and execution times associated with a node or actor executing. In this example, the transfer and execution times for each node execution are represented by rectangular regions connected to the execution timing arrows. Note that any arrows that line up vertically will execute at the same time, and that the diagram clearly indicates which inputs and outputs are simultaneous. Moreover, as shown, the isochronous transfer arrows may originate on the right side of the rectangular regions to indicate that the data are not sent until the node finishes executing (for that cycle).

In some embodiments, the method may further include receiving user input to the timing diagram modifying the determined invocation timing relationships among the two or more function nodes. For example, the user may move, delete, etc., various of the elements in the timing diagram, as desired. Thus, for example, the user may modify the transfer and execution time period, e.g., possibly increasing, but not reducing it beyond a certain amount, since there may be platform dependent times or durations associated with data transfer and propagation delays. In this exemplary embodiment, shifting the arrows (left or right) changes the offset within the period. Also if a node or actor is shown executing multiple times; then moving one arrow moves the other ones automatically. For example, in FIG. 9, if the user moves the firing time of “motor controller program 710” to the right at time “0” all the arrows for “motor controller program 710” automatically move to the right by the same amount.

Note that execution rates and offsets are clearly visible and modifiable on the timing diagram of FIG. 9, and thus easier to quickly understand and manage using this timing diagram (view), as compared to the system diagram of FIG. 8.

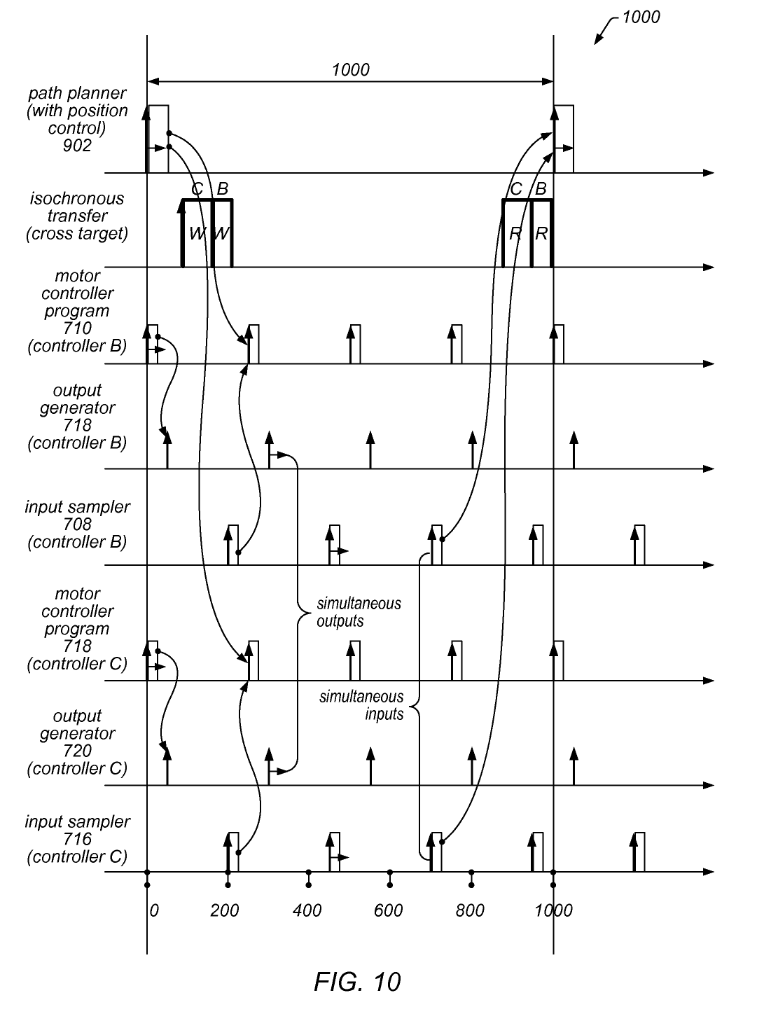

In some embodiments, the user may change the way the isochronous data are transferred. For example, in the timing diagram FIG. 9, the method (e.g., the compiler) automatically put the isochronous reads and writes (row 2 R's and W's) together, since this may be the safest approach without knowing exactly the computation time for the “path planner” node or actor. FIG. 10 illustrates a modified version of the timing diagram of FIG. 9, where the user has edited the timing diagram to move the writes to the beginning of the period. Thus, if advanced users have sufficient knowledge about the execution times, they may change the writes and reads as shown in FIG. 10 to reduce the lag in the system.

In some embodiments, in response to at least some of the changes made to the timing diagram, the method may include automatically updating the system diagram accordingly.

Once the timing for the system has been specified, the graphical program (portion of the system diagram) may be deployable and executable in a distributed manner on the devices according to the determined invocation timing relationships, where during execution of the graphical program, data are transferred isochronously between the two or more function nodes. Thus, in one embodiment, the method may include deploying the graphical program on the devices, including deploying each of the respective one or more function nodes to their associated devices, and executing the graphical program, including executing the respective one or more function nodes on their devices.

Thus, isochronous connections between actors or nodes in a system diagram may facilitate determination of phase relationships between execution times of these actors or nodes, where the actors or nodes can be on the same target or across distributed targets. Additionally, a timing view may be used to show the time line view of actors or nodes connected isochronously. This view may also indicate production/consumption data dependencies between these actors or nodes.

Thus, embodiments of the above method may operate to specify and implement isochronous data transfer among nodes of a graphical program distributed in and across multiple devices.

### Creating a Graphical Program or System Diagram

Below are described various ways of generating a graphical program or a system diagram, which for brevity may simply be referred to below as a graphical program.

A graphical program may be created or assembled on the computer system 82 (or on a different computer system by the user arranging on a display a plurality of nodes or icons and then interconnecting the nodes to create the graphical program (or system diagram). In response to the user assembling the graphical program, data structures may be created and stored which represent the graphical program. The nodes may be interconnected in one or more of a data flow, control flow, or execution flow format, among others. The graphical program may thus include a plurality of interconnected nodes or icons which visually indicates the functionality of the program (or system diagram). As noted above, the graphical program may include a block diagram and may also include a user interface portion or front panel portion. Where the graphical program includes a user interface portion, the user may optionally assemble the user interface on the display. As one example, the user may use the LabVIEW graphical programming development environment to create the graphical program.

In an alternate embodiment, the graphical program may be created by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired.

It is noted that the graphical user interface and the block diagram may be created separately or together, in various orders, or in an interleaved manner. In one embodiment, the user interface elements in the graphical user interface or front panel may be specified or created, and terminals corresponding to the user interface elements may appear in the block diagram in response. For example, when the user places user interface elements in the graphical user interface or front panel, corresponding terminals may appear in the block diagram as nodes that may be connected to other nodes in the block diagram, e.g., to provide input to and/or display output from other nodes in the block diagram. In another embodiment, the user interface elements may be created in response to the block diagram. For example, the user may create the block diagram, where the block diagram includes terminal icons or nodes that indicate respective user interface elements. The graphical user interface or front panel may then be automatically (or manually) created based on the terminal icons or nodes in the block diagram. As another example, the graphical user interface elements may be included in the diagram.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method, comprising:
utilizing a computer to perform:
displaying a system diagram on a display of the computer, wherein the system diagram comprises a plurality of device icons corresponding to respective devices, wherein each device icon has an associated respective one or more executable function nodes specified for deployment on the corresponding device, wherein the function nodes are interconnected to form a distributed graphical program that is deployable and executable in a distributed manner on the devices;
receiving user input to the system diagram specifying isochronous data transfer among two or more of the function nodes;
automatically determining invocation timing relationships among the two or more of the function nodes based on the specified isochronous data transfer, including determining phase relationships between execution of the two or more function nodes;
displaying the determined invocation timing relationships among the two or more function nodes;
wherein the graphical program is deployable and executable in a distributed manner on the devices according to the determined invocation timing relationships, and wherein during execution of the graphical program, data are transferred isochronously between the two or more function nodes.

2. The computer-implemented method of claim 1, wherein said receiving user input to the system diagram specifying isochronous data transfer among two or more of the function nodes comprises:
receiving user input interconnecting the two or more function nodes, wherein each interconnection comprises an isochronous data flow wire that a specifies isochronous data transfer between two function nodes.

3. The computer-implemented method of claim 1, wherein each device comprises a clock, the method further comprising:
utilizing the computer to perform:
receiving user input specifying a clock hierarchy among the clocks of the device;
wherein during execution of the graphical program, the specified clock hierarchy is used to synchronize the clocks to achieve and maintain the determined phase relationships between execution of the two or more function nodes.

4. The computer-implemented method of claim 3,
wherein each device node comprises a clock symbol that represents a corresponding clock on the respective device, wherein one of the clocks is specified as a master clock; and
wherein said receiving user input specifying a clock hierarchy comprises receiving user input interconnecting the clock symbol representing the master clock with each of the other clock symbols via a respective clock disciplining wire that specifies a master/slave relationship between the master clock and each of the other clocks.

5. The computer-implemented method of claim 1, further comprising:
utilizing the computer to perform:
receiving user input to the system diagram specifying execution rates for the two or more function nodes;
wherein during execution of the graphical program, the two or more function nodes execute according to their respective specified execution rates.

6. The computer-implemented method of claim 5,
wherein during execution of the graphical program, if input data are not available to a function node on the isochronous data flow wire, the function node continues to execute in accordance with the function node's specified execution rate using previously received input data.

7. The computer-implemented method of claim 5, wherein said displaying the determined invocation timing relationships among the two or more function nodes comprises:
displaying a timing generator in the system diagram, wherein the timing generator comprises a control node that orchestrates invocation and execution of function nodes in and across devices; and
displaying timed invocation wires connecting the timing generator to each of the two or more function nodes in the system diagram, wherein each timing wire indicates an invocation period for the connected function node.

8. The computer-implemented method of claim 7,
wherein at least one timing wire further indicates an execution offset for the connected function node, wherein the execution offset specifies a delay in execution of the connected function node with respect to execution of another function node that provides input data to the connected function node; and
wherein during execution of the graphical program, the connected function node executes at its specified execution rate but with the execution offset with respect to the other function node.

9. The computer-implemented method of claim 7, wherein said displaying the determined invocation timing relationships among the two or more function nodes comprises:
displaying a timing diagram indicating the determined invocation timing relationships among the two or more function nodes, wherein the timing diagram further indicates input/output data dependencies among the two or more function nodes;
wherein the timing generator represents the timing diagram.

10. The computer-implemented method of claim 9, further comprising:
utilizing the computer to perform:
receiving user input to the timing diagram modifying the determined invocation timing relationships among the two or more function nodes.

11. The computer-implemented method of claim 1, further comprising:
utilizing the computer to perform:
deploying the graphical program on the devices, including deploying each of the respective one or more function nodes to their associated devices;
executing the graphical program, including executing the respective one or more function nodes on their devices.

12. The computer-implemented method of claim 1,
wherein the system diagram specifies a distributed control system.

13. The computer-implemented method of claim 1,
wherein the system diagram specifies a distributed timed data acquisition system.

14. The computer-implemented method of claim 1,
wherein the system diagram specifies a distributed audio and/or video system.

15. The computer-implemented method of claim 1,
wherein the graphical program comprises a graphical data flow program.

16. A system, comprising:
a processor;
a display, coupled to the processor;
a memory, coupled to the processor, wherein the memory stores program instructions executable by the processor to:
display a system diagram on the display, wherein the system diagram comprises a plurality of device icons corresponding to respective devices, wherein each device icon has an associated respective one or more executable function nodes specified for deployment on the corresponding device, wherein the function nodes are interconnected to form a distributed graphical program that is deployable and executable in a distributed manner on the devices;
receive user input to the system diagram specifying isochronous data transfer among two or more of the function nodes;
automatically determine invocation timing relationships among the two or more of the function nodes based on the specified isochronous data transfer, including determining phase relationships between execution of the two or more function nodes;
display the determined invocation timing relationships among the two or more function nodes;
wherein the graphical program is deployable and executable in a distributed manner on the devices according to the determined invocation timing relationships, and wherein during execution of the graphical program, data are transferred isochronously between the two or more function nodes.

17. The computer-implemented method of claim 16, wherein to receive user input to the system diagram specifying isochronous data transfer among two or more of the function nodes, the program instructions are executable to:
receive user input interconnecting the two or more function nodes, wherein each interconnection comprises an isochronous data flow wire that a specifies isochronous data transfer between two function nodes.

18. The system of claim 16, wherein each device comprises a clock, and wherein the program instructions are further executable by the processor to:
receive user input specifying a clock hierarchy among the clocks of the devices;
wherein during execution of the graphical program, the specified clock hierarchy is used to synchronize the clocks to achieve and maintain the determined phase relationships between execution of the two or more function nodes.

19. The system of claim 18,
wherein each device node comprises a clock symbol that represents a corresponding clock on the respective device, wherein one of the clocks is specified as a master clock; and
wherein to receive user input specifying a clock hierarchy, the program instructions are executable to receive user input interconnecting the clock symbol representing the master clock with each of the other clock symbols via a respective clock disciplining wire that specifies a master/slave relationship between the master clock and each of the other clocks.

20. The system of claim 16, wherein the program instructions are further executable by the processor to:
receive user input to the system diagram specifying execution rates for the two or more function nodes;
wherein during execution of the graphical program, the two or more function nodes execute according to their respective specified execution rates.

21. The system of claim 20,
wherein during execution of the graphical program, if input data are not available to a function node on the isochronous data flow wire, the function node continues to execute in accordance with the function node's specified execution rate using previously received input data.

22. The system of claim 20, wherein to display the determined invocation timing relationships among the two or more function nodes, the program instructions are executable to:
display a timing generator in the system diagram, wherein the timing generator comprises a control node that orchestrates invocation and execution of function nodes in and across devices; and
display timed invocation wires connecting the timing generator to each of the two or more function nodes in the system diagram, wherein each timing wire indicates an invocation period for the connected function node.

23. The system of claim 22,
wherein at least one timing wire further indicates an execution offset for the connected function node, wherein the execution offset specifies a delay in execution of the connected function node with respect to execution of another function node that provides input data to the connected function node; and
wherein during execution of the graphical program, the connected function node executes at its specified execution rate but with the execution offset with respect to the other function node.

24. The system of claim 22, wherein to display the determined invocation timing relationships among the two or more function nodes, the program instructions are executable to:
display a timing diagram indicating the determined invocation timing relationships among the two or more function nodes, wherein the timing diagram further indicates input/output data dependencies among the two or more function nodes.

25. The system of claim 24, wherein the program instructions are further executable to:
receive user input to the timing diagram modifying the determined invocation timing relationships among the two or more function nodes.
